(19) United States
(12) Patent Application Publication
(10) Pub. No.: US 2024/0257056 A1
(43) Pub. Date: Aug. 1, 2024

(54) INFRASTRUCTURE PROJECT MANAGEMENT AND DEPLOYMENT TRACKING APPLICATION

(71) Applicant: T-Mobile USA, Inc., Bellevue, WA (US)

(72) Inventors: Anselmo Myungsup Shim, Bellevue, WA (US); Muhammad Irfan Farooq, Maple Valley, WA (US); Mary Lynn Mireles, Herndon, VA (US)

(21) Appl. No.: 18/101,808

(22) Filed: Jan. 26, 2023

(51) Int. Cl. G06Q 10/10; G06Q 10/0631; G06Q 10/0633

(52) U.S. Cl. CPC G06Q 10/103; G06Q 10/063114; G06Q 10/0633

(57) ABSTRACT

Methods and systems for infrastructure project management and deployment tracking application are disclosed. According to an implementation, a computing device may manage a plurality of standardized templates indicative of workflows of a plurality of projects stored in a centralized database. Upon receiving a request to deploy a project in the network, the computing device may retrieve, from the database, a template corresponding to the project, and render a graphical user interface for the project. The computing device may present the graphical user interface on the computing devices/servers on a plurality of platforms where the various tasks are executed. In implementations, the graphical user interface may be configured to guide a plurality of teams engaged in the project to execute the tasks on the corresponding platforms according to the workflow indicated by the template.

### BACKGROUND

Project management and deployment in a company involves multiple teams to collaborate. A new project typically involves the stakeholders across several different organizations. Teams across the company use different project trackers and the documents required for the project are often hosted in different locations. Tickets are opened against the teams that use different ticketing systems. It is hard to organize these tickets in one workstream and keep track of the ticket status. In addition, the current deployment tracking system cannot efficiently maintain and share the documentations hosted in different locations with the teams engaged in a project and has no availability to version controls. Some existing third party solutions can track the issues or tasks for specific applications at the software/business layer. However, tracking the deployment status at the infrastructure layer is challenging.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network scenario, in which methods for infrastructure project management and deployment tracking are implemented, according to an existing technique.

FIG. 2 illustrates an example network scenario, in which methods for infrastructure project management and deployment tracking are implemented, according to an example of the present disclosure.

FIG. 3 illustrates an example workflow, in which methods for infrastructure project management and deployment tracking for a software release are implemented, according to another example of the present disclosure.

FIG. 4 illustrates an example view of a graphical user interface generated to guide the infrastructure project management and deployment tracking for a software release, according to an example of the present disclosure.

FIG. 5 illustrates another example view of a graphical user interface generated to guide the infrastructure project management and deployment tracking for a software release, according to an example of the present disclosure.

FIG. 6 illustrates an example workflow, in which methods for infrastructure project management and deployment tracking for deploying a new hardware, are implemented, according to an example of the present disclosure.

FIG. 7 illustrates an example view of a graphical user interface generated to guide the infrastructure project management and deployment tracking for deploying a new hardware, according to another example of the present disclosure.

FIG. 8 illustrates another example view of a graphical user interface generated to guide the infrastructure project management and deployment tracking, according to yet another example of the present disclosure.

FIG. 9 illustrates an example process for infrastructure project management and deployment tracking, according to an example of the present disclosure.

FIG. 10 illustrates an example process for infrastructure project management and deployment tracking, according to yet another example of the present disclosure.

FIG. 11 illustrates an example computing device, in which methods for infrastructure project management and deployment tracking are implemented, according to an example of the present disclosure.

### DETAILED DESCRIPTION

Techniques for infrastructure project management and deployment tracking application are disclosed herein. In some implementations, a method for infrastructure project management and deployment tracking application may be implemented on a computing device or a server device on the network infrastructure.

In implementations, a computing device on a network infrastructure may manage a plurality of templates indicative of workflows of a plurality of projects. The plurality of templates may include standardized templates created for the projects in the past. The computing device may store the plurality of standardized templates in a centralized database. Upon receiving a request to deploy a project in the network, the computing device may retrieve a template corresponding to the project from the centralized database. As discussed herein, the project may include a plurality of tasks that need to be completed by a plurality of teams engaged in the project. In examples, the plurality of teams may implement different platforms, ticketing systems, and/or tracking applications. In implementations, once the project kicks off, the plurality of tasks may be sequentially passed to a plurality of platforms used by the plurality of teams, respectively. In implementations, the computing device may further render a graphical user interface for the project deployment. The graphical user interface may demonstrate a dynamic workflow to complete the project and display the real-time information associated with the deployment. The computing device may transmit the data associated with the graphical user interface to the plurality of platforms, causing the graphical user interface to be displayed on the computing devices/servers on the plurality of platforms. In implementations, the graphical user interface may be configured to guide the plurality of teams to execute the corresponding tasks on the corresponding platforms according to the workflow indicated by the template.

In implementations, the computing device may retrieve, from the database, documentations required to complete the project and associate the documentations with the plurality of tasks of the project. The computing device may present a first view of the graphical user interface on the plurality of platforms. As discussed herein, the first view may include at least information of a first documentation required for a first task, a first team that enforces the first task, status of the first task, issues generated while enforcing the first task, etc. In some examples, the computing device may further receive, from a first platform, an interaction on the first view by a user of the first team. In some examples, the interaction may cause a completion of the first task on the first platform.

In some examples, the computing device may monitor the progress of the deployment and generate subsequent views of the graphical user interface to reflect the progress of the deployment. The subsequent views of the graphical user interface may be simultaneously updated on the computing devices/servers on the plurality of platforms. As discussed herein, each of the subsequent views may include at least a completion status of one or more previous tasks, information of a current documentation required for a current task, status of the current task, tickets being opened so far, status of these tickets, downstream tasks not yet started, etc. Upon determining that the current task is completed, the computing device may update the graphical user interface to guide a downstream team in the workflow to execute a subsequent task.

In some examples, the computing device may track all activities on the plurality of platforms that are associated with completing the project. Data associated with these activities may be stored in the centralized database. In some examples, Data associated with these activities may be used to analyze an issue in the deployment or for regression tests.

In some examples, the project may include deploying a new hardware in the network. The new hardware may be a computing device/server device, a switch, a router, a datacenter device, a base station or other access device, etc. The computing device may obtain a template standardizing a workflow for adding a new hardware from the centralized database. In some examples, the computing device may build a new template based on the deployment requirements. In yet other examples, the computing device may revise the obtained template based on the deployment requirements. The computing device may determine one or more teams to engage the project such as a design team, a lab testing team, an advanced technology support (ATS) testing team, FOA production team, etc. The computing device may align the one or more teams according to the standardized workflow of the project and generate a graphical user interface to guide the one or more teams to complete their respective tasks following the workflow. In some examples, the design team may gather information related to the deployment requirements, documentations required to complete the project, technical details of the project, etc. The lab testing team may validate the design in a lab environment before the new hardware is added to the network. The ATS testing team may further test the new hardware in the network after onboarding the new hardware. The FOA production team may complete the project of adding the new hardware, collecting project metrics, and prepare project closure documentations.

In some examples, the project may include releasing a new software or a new version of a software to the components in the network. Similarly, the computing device may obtain a template standardizing a workflow for releasing a software from the centralized database. The computing device may determine one or more teams to engage the project such as a design team, a lab testing team, an advanced technology support (ATS) testing team, FOA production team, etc. The computing device may align the one or more teams according to the standardized workflow of the project and generate a graphical user interface to guide the one or more teams to complete their respective tasks following the workflow. In some examples, the design team may gather information related to the release criteria, documentations required to complete the project, previous versions of the software, etc. The lab testing team may validate the design in a lab environment before the new software and/or the new version is released to the components of the network. In some examples, the lab testing team may validate the design that bundles the previous versions of the software. The ATS testing team may further test the new software in the network after it is released to the network components. The FOA production team may complete the project, collecting software quality metrics, and prepare project closure documentations.

The techniques discussed herein may be implemented in a computer network using one or more of protocols including but are not limited to Ethernet, 3G, 4G, 4G LTE, 5G, 6G, the further radio access technologies, or any combination thereof. In some examples, the network implementations may support standalone architectures, non-standalone architectures, dual connectivity, carrier aggregation, etc. Example implementations are provided below with reference to the following figures.

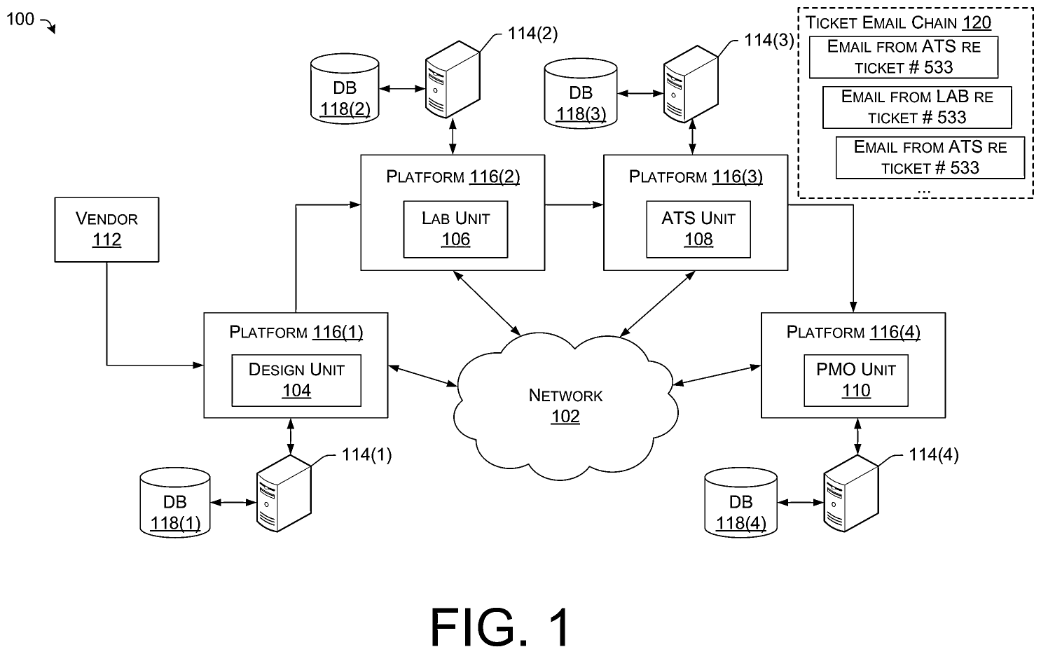

FIG. 1 illustrates an example network scenario, in which methods for infrastructure project management and deployment tracking are implemented, according to an existing technique.

The network scenario 100, as illustrated in FIG. 1, may include a plurality of servers 114(1), 114(2), 114(3), and 114(4) (hereinafter referred to as the computing device 114) collaboratively connected to each other through a network 102. Each of the servers 114(1), 114(2), 114(3), and 114(4) may be configured to provide services through a respective platform implemented therein, for example, platform 116(1), 116(2), 116(3), and 116(4) (hereinafter referred to as the platform 116). The platform 116 may be a legacy platform, a non-legacy platform, a containerized platform, etc. In implementations, a database may be locally coupled to the server 114. For example, the database 118(1), 118(2), 118(3), and 118(4) (hereinafter referred to as the database 118) may be coupled to the servers 114(1), 114(2), 114(3), and 114(4), respectively. Although the server 114, the platform 116, and the database 118 are shown as separate elements, the platform 116 may be implemented on the server 114 by installing a software or a bundled software package on the server 114. In some examples, the platform 116 may include operations systems such as Windows, Mac operating system, Android, iOS, Unix, Unix-like operating system, cloud environment, etc. In implementations, the function of the database 118 may also be integrated to the storage of the server 114. In addition, the server 114 may include a single computing device, a cluster of computing devices, a virtual computing device on a cloud environment, etc.

The network 102 may be a telecommunication network of a service provider such as, T-Mobile, Verizon, AT&T, etc. The network 102 may include one or more core networks such as a Fifth Generation (5G) core network, a Fourth Generation long term evolution (4G LTE) network, an evolved packet core (EPC) network, etc. In implementations, the one or more core networks may be in different geographic locations.

In some examples, a vendor 112 may provide information of new products such as new hardware, new software, a new version of an existing software, or the combination thereof to the service provider to be deployed in the network 102. The hardware, for example, may include a computing device or a server device, a router, a switch, a base station, a datacenter equipment, etc. The project may require multiple teams of the service provider to collaborate together to complete such as business units and/or technical teams. Quite often, the multiple teams of the service provider may operate on different platforms and each team may have its own issue tracking system, ticketing system, local storage, etc.

As illustrated in FIG. 1, a design unit 104 may be implemented on the server 114(1) and configured to perform a design task on the platform 116(1), a lab unit 106 may be implemented on the server 114(2) and configured to perform a lab testing task on the platform 116(2), an advance technology support (ATS) unit 108 may be implemented on the server 114(3) and configured to perform the ATS testing after onboarding the new hardware and/or software on the platform 116(3), and a project management office (PMO) unit 110 may be implemented on the server 114(4) and configured to close out the project after a successful deployment and prepare reporting of the deployment on the platform 116(4). When a new project includes one or more tasks to be executed by one or more teams, due to different types of platforms and tracking systems used by the one or more teams, the downstream teams may have no knowledge of the progress until the upstream task is completed. The status of the entire project along the workflow cannot be efficiently shared in one place. Likewise, it may also be difficult for the upstream teams to trace the deployment progress after completing their own tasks. In addition, as different teams may use different platforms, tracking systems, and/or ticketing systems, issues to be collaboratively solved among the teams have to be communicated in emails. As shown in FIG. 1, deploying a new project can generate at least a ticket email chain 120, which includes multiple emails sent back and forth among different teams.

To address the deficiencies in the infrastructure project management and deploy tracking, the present disclosure creates a graphical user interface to dynamically guide the multiple teams to complete the project step by step. The graphical user interface may be presented simultaneously on the interfaces of the computing devices/servers associated with the multiple teams. The progress of the project and all activities associated with deploying the project in multiple platforms are collected and presented dynamically on the graphical user interface.

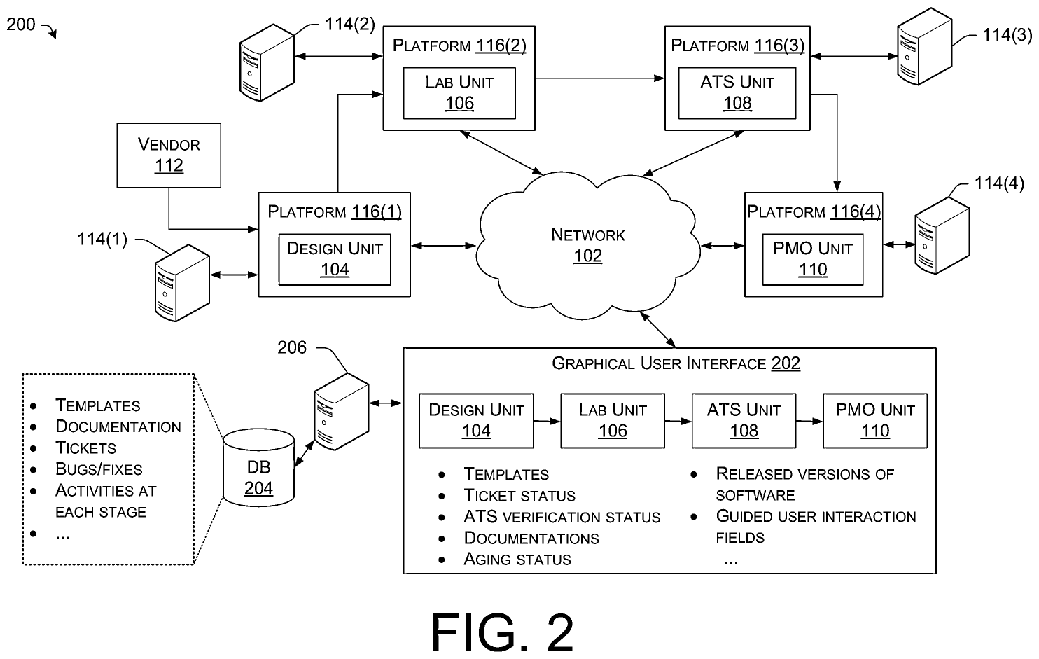

FIG. 2 illustrates an example network scenario, in which methods for infrastructure project management and deployment tracking are implemented, according to an example of the present disclosure.

Aside from the network elements shown in FIG. 1, the network scenario 200 may further include a computing device/server 206 connected to the network 102. Upon receiving a new project, the computing device/server 206 may start gathering information related to business requirements, determine one or more teams to collaborate to complete the project, and determine the technical details for the deployment. The computing device/server 206 may further determine a workflow to deploy the project and align the one or more teams according to the workflow.

In the example shown in FIG. 2, the new project may include four tasks required to be sequentially completed by the design unit 104, the lab unit 106, the ATS unit 108, and the PMO unit 110, respectively. The deployment workflow may include project design as phase 1 task, lab testing as phase 2 task, ATS testing as phase 3 task, and project closeout as phase 4 task. The deployment may progress to the downstream phase in the workflow when a current phase is completed. In some examples, upon the new project starts, the computing device/server 206 may determine the documentations required for the new project. The documentations may include one or more sets of documents that are required to check at different phases. By way of example and without limitation, the documentations may include high level design and architecture, project scope statement, project schedule, communication, marketing plans, deployment plan, dependencies and constraints, action item tracker, detailed technical and business requirements, architecture diagram, test plan, success criteria, pass/fail definition, user guide, troubleshooting guide, etc.

The computing device/server 206 may build a graphical user interface 202 to present the dynamic workflow, the progress of the project at various phases, the actions required to take before progressing to the next phase, the issues occurred at various phases, the tickets generated at various phases and the status of the tickets, etc. The computing device/server 206 may transmit data associated with the graphical user interface 202 through the network 102 to the computing devices/servers of the engaged teams such as the server 114(1), server 114(2), server 114(3), server 114(4), etc. The transmission may cause the graphical user interface 202 to be displayed on the interfaces of these servers, providing a dynamic view of the entire workflow of the project and guiding each team in the workflow to complete the task.

The computing device/server 206 may maintain a pool of the standardized templates used for the past projects in a database 204. Based on the received project, the computing device/server 206 may select an appropriate template from the pool for the project. When no suitable template is found, the computing device/server 206 may create a new template for the project. In some examples, the standardized template and/or the new template may define the information to be included in the graphical user interface including but not limited to, the teams engaged in the project (e.g., business units, technical teams, etc.), the documentations required to check by each individual team, actions required to complete before moving forward to the next team, issues occurred during the deployment, ticket status in real-time, ATS testing/verification status, aging status, versions of the software already implemented in the network infrastructure, etc.

Although not shown in the network scenario 200, in some examples, the graphical user interface 202 may also be displayed on the interfaces of other servers not engaged in the project workflow such as, other management teams or other executive teams of the company.

During the deployment, the computing device/server 206 may monitor the real-time progress of the project on multiple platforms. The computing device/server 206 may collect real-time information associated with the tasks performed on the multiple platforms such as user interactions with the graphical user interface 202 presented on the multiple platforms, issues/bugs detected on the multiple platforms, tickets issued from the multiple platforms, etc. The computing device/server 206 may further update the data associated with the graphic user interface 202 with the collected real-time information, causing the graphic user interface 202 displayed on different platforms to present the real-time progress of the project to all the teams.

In implementations, an initial view of the graphical user interface 202 may show that the new project is initiated and the progress is now at phase 1, e.g., project design. The initial view of the graphical user interface 202 may provide a checklist of documentations for the design unit 104 to review and/or check before handing the project over to phase 2. In some examples, the initial view may further include one or more user interaction fields for the user to provide inputs, select items, upload documents, etc. The computing device/server 206 may monitor the user interactions with the graphical user interface 202 and update the initial view based at least in part on the user interactions to generate one or more subsequent views. The computing device/server 206 may transmit data associated with the one or more subsequent views to the downstream teams such that the downstream teams can track the real-time progress of the project at their respective platforms.

In some examples, when a task is completed by a current team, the deployment moves on to a downstream team to perform a subsequent task in the workflow. The computing device/server 206 may continue to monitor the user interactions with the graphical user interface 202 presented on the downstream platforms and dynamically update the current view of the graphical user interface 202 based at least in part on the collected user interactions on the downstream platforms. The computing device/server 206 may simultaneously update the views of the graphical user interface 202 displayed on the upstream platforms such that the upstream teams may also keep track of the real-time progress of the project.

In some examples, a downstream team, e.g., the ATS unit 108, may found an issue that require an upstream team, e.g., the lab unit 106, to fix. A ticket opened from the platform of the ATS unit 108 may be instantly shared to all team engaged in the project via the graphical user interface 202. The lab unit 106 that is alerted by the sharing may start to fix the issue. The status of the ticket may be further updated on the graphical user interface 202 presented to all the teams simultaneously. In some examples, the graphical user interface 202 may further include a dialog window to facilitate the communications among various teams.

In some examples, the computing device/server 206 may save the information associated with the project deployment in the database 204, e.g., the collected activities at the multiple platforms during the deployment. As discussed herein, the database 204 may be a centralized database that stores the standardized templates associated with various projects, the documentations required for deploying the various projects, tickets issued during the deployments, bugs/fixes generated during the deployments, etc.

According to the present disclosure, the computing device/server 206 may store the documentations required for the project and the standardized templates in a centralized database. The computing device/server 206 may generate the graphical user interface 202 using the standardized templates to guide various teams of a company to enforce the respective tasks according to a workflow toward completing the project. Further, the graphical user interface 202 may be dynamically displayed on the interfaces of the computing devices associated with the various teams. The progress of the project and the activities collected on multiple platforms may be tracked and shared to all the teams engaged in the project via the graphical user interface 202 in real-time. As such, the present disclosure may provide a solution to collaborate multiple teams to efficiently deploy a new project in the network infrastructure level.

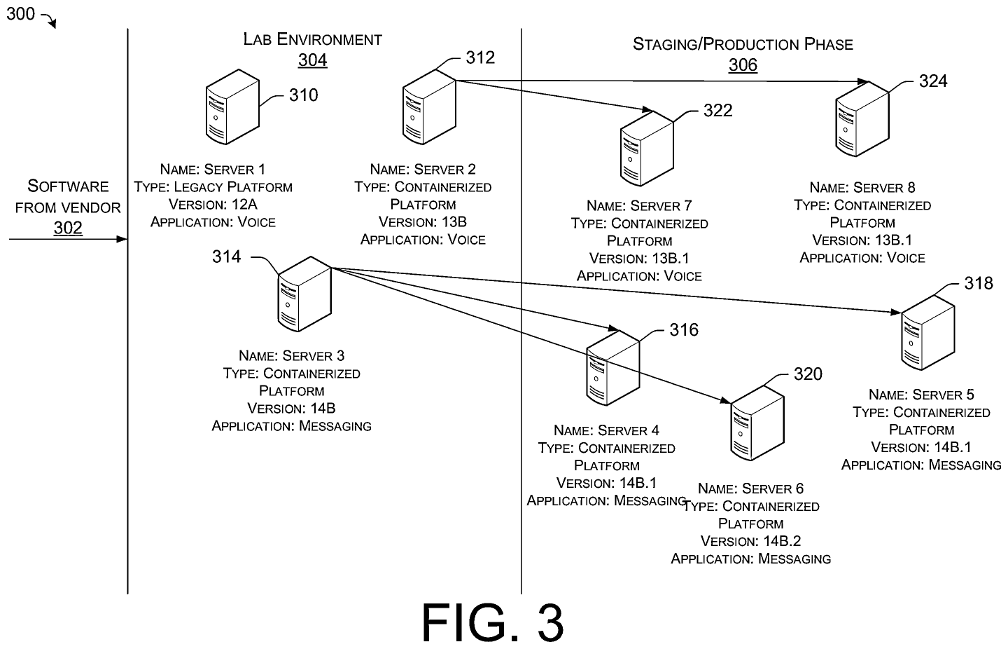

FIG. 3 illustrates an example workflow, in which methods for infrastructure project management and deployment tracking for a software release are implemented, according to another example of the present disclosure.

According to the network scenario 300, a software from the vendor 302 is to be deployed in the network. A lab environment 304 may include multiple servers such as server 310, server 312, server 314, etc. The multiple servers may implement different platforms, different software, or different versions of a software. For example, the server 310 implements a legacy platform and has installed a voice application with a version 12A. The server 312 implements a containerized platform and has installed a voice application with a version 13B. The server 314 implements a containerized platform and has installed a messaging application with a version 14B. The staging/production phase 306 may include a plurality of servers in the network such as server 316, server 318, server 320, server 322, server 324, etc. As shown, the plurality of servers may implement the containerized platforms. The server 316, 318, and 320 may have installed the messaging application with different versions. The server 322 and 324 may have installed the same version of the voice application. As illustrated in FIG. 3, when the software from the vendor 302 is tested in the lab environment 304, it may be released to one or more servers at the staging/production phase 306. For instance, if the software from the vendor 302 include a voice application, the voice application may be released to server 322 and/or server 324, which previously installed the voice application. If the software from the vendor 302 include a messaging application, the messaging application may be released to one or more of server 316, server 318, or server 320 in the network.

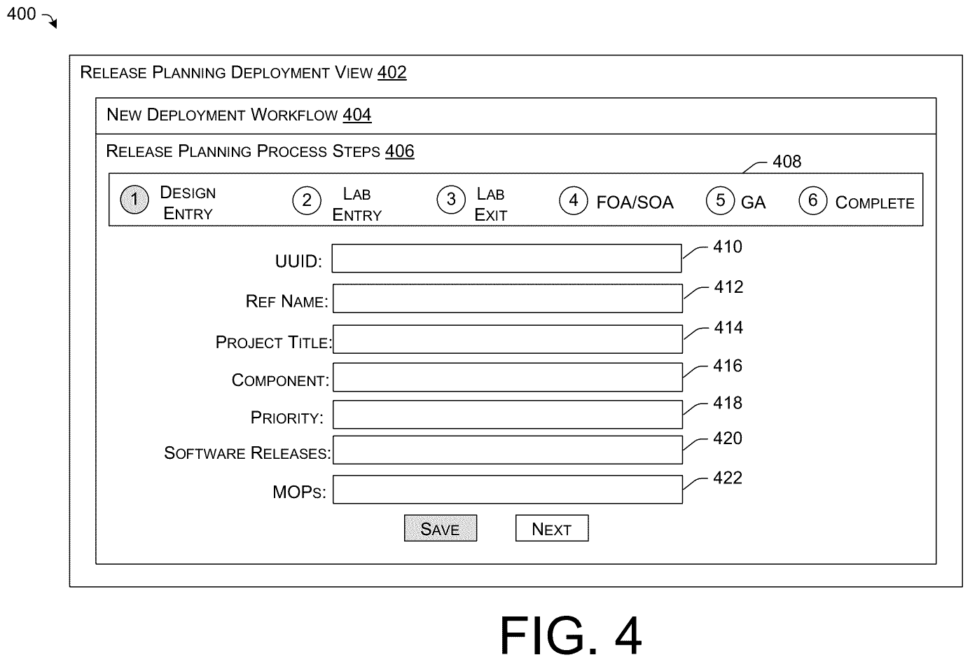

FIG. 4 illustrates an example view of a graphical user interface generated to guide the infrastructure project management and deployment tracking for a software release, according to an example of the present disclosure.

The example view 400 of a graphical user interface may correspond to the example workflow 300 shown in FIG. 3, in which methods for infrastructure project management and deployment tracking for a software release are implemented.

As illustrated in FIG. 4, a release planning deployment view 402 may include a new deployment workflow 404. The new deployment workflow 404 may indicate one or more stages/phases 408 that the deployment needs to go through. For example, the one or more stages/phases 408 may include a design entry phase, a lab entry phase, a lab exit phase, a FOA/SOA phase, a general availability (GA) phase, and a complete phase. A release planning process step 406 may indicate a current phase or step that the release planning deployment is at. In implementations, the current phase or step, e.g., the design entry phase, may be highlighted in different color, font, pattern, etc. As discussed herein, the release planning deployment view 402 may be an initial view of the graphical user interface generated for the project, where the project is at the design entry phase. In implementations, the release planning deployment view 402 may correspond to the graphical user interface 202 generated by the computing device/server 206, as shown in FIG. 2. The design entry phase may be performed by the design unit 104, as shown in FIG. 2.

In some examples, the new deployment workflow 404 may include a plurality of user interaction fields that allow the user to view and/or complete at the current phase. For example, at the design entry phase, the new deployment workflow 404 may include a universally unique identifier (UUID) field 410 that allows the user to input or select the UUID number, a Ref Name field 412 that allows the user to input or select a reference name of the project, a Project Title field 414 that allows the user to input or select the project title, a Component field 416 that allows the user to input or select the components or teams associated with the project, a Priority field 418 that allows the user to input or select the priority level of the project, a Software Releases field 420 that allows the user to input or select the versions of the software previously released, a method of procedures (MOPs) field 422 that allows the user to input or select other methods of procedures for the project, etc.

As discussed herein, the computing device/server 206 of FIG. 2 maintains the information of software releases in the database 204. The Software Releases field 420 may provide the software versions in the past releases. Such information may include a day by day timeline of the software versions installed on each node or server. In examples, such information may further include enhanced level of details for auditing and cross referencing when outages and/or issues occurs. In some examples, the information of the software versions released in the past may be illustrated in charts, figures, Excels, etc. Through the Software Releases field 420, the user at the design entry phase may choose to bundle the previous software versions with the new version to release to the network nodes/servers.

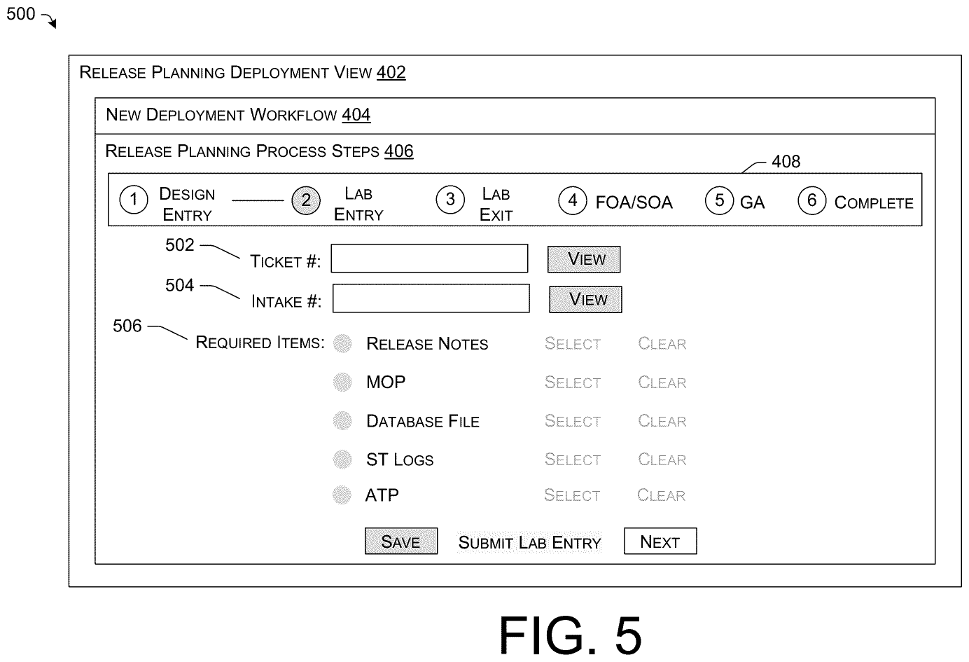

FIG. 5 illustrates another example view of a graphical user interface generated to guide the infrastructure project management and deployment tracking for a software release, according to an example of the present disclosure.

The example view 500 may correspond to an updated view of the graphical user interface, subsequent to the example view 400 shown in FIG. 4. As illustrated in FIG. 5, the release planning deployment view 402 may indicate that the new deployment workflow 404 has completed the design entry phase and is now at the lab entry phase.

At the lab entry phase, the release planning deployment view 402 may also include a plurality of user interaction fields that allow the user to view and complete at the lab entry phase. For example, at the lab entry phase, the new deployment workflow 404 may include a Ticket # field 502 that allows the user to input or select a ticket number, an Intake # field 504 that allows the user to input or select an intake number, required items field 506 that allows the user to select the items required to complete the lab testing, etc. In some examples, the required times for the lab testing may include release notes, MOP, database file, ST logs, ATP, etc. Once all the required items are selected, the user may submit the lab entry request by clicking the “submit lab entry” button.

As discussed herein, the release planning deployment view 402, as a graphical user interface generated to provide a step-by-step guidance to various teams to complete the project, may be present simultaneously on the computing devices associated with the various teams. For instance, the example view 400 corresponding to the design entry phase may be also viewed by the teams that would subsequently perform lab testing, FOA/SOA production, GA closeout, etc. Similarly, the example view 500 corresponding to the lab entry phase may be also viewed by the team that completed the design phase. In some examples, an issue occurred in a downstream phase may trigger a regression test in the lab testing/validation phase. The graphical user interface may include other views with information associated with the actions being taken, issues being generated and/or solved, etc., so that the users at various phases may analyze the information to determine a solution for the regression test.

It should be appreciated that the example views of FIG. 4 and FIG. 5 are for illustrative purposes. The present disclosure is not intended to be limiting. Various views of the graphical user interface may include different information and/or user interactions fields, depending on the type of the new project.

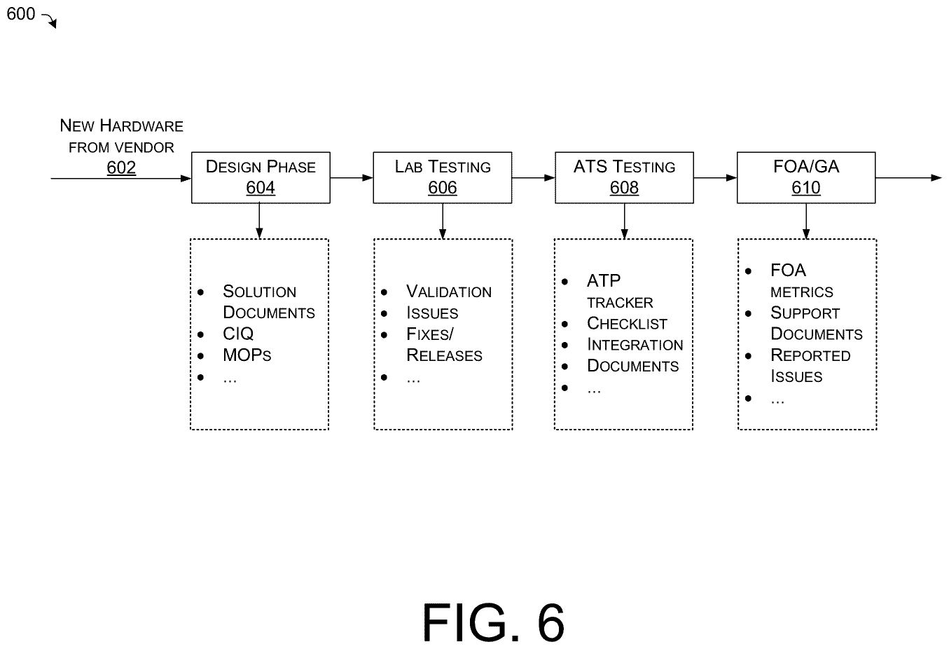

FIG. 6 illustrates an example workflow, in which methods for infrastructure project management and deployment tracking for deploying a new hardware, are implemented, according to an example of the present disclosure.

As illustrated in FIG. 6, a new hardware from the vendor 602 may be deployed in the network. The example workflow 600 may indicate one or more phases that the deployment needs to go through. By way of example but without limitation, the one or more phases may include a design phase 604, a lab testing phase 606, an ATS testing phase 608, and an FOA/GA phase 610. The team at the design phase 604 may gather information such as customer information questionnaire (CIQ), method of procedure (MOP), solution documents required for the project, etc. The team at the lab testing phase 606 may perform validation on the project design in a lab environment, detect bugs and fix issues associated with the project design, etc. The team at the ATS testing phase 608 may perform ATP tracking, review the checklist and/or documents for production, onboard the new hardware to the network infrastructure, etc. The FOA/SOA phase 610 may perform the actual production, generate FOA metrics, generate supporting documents associated with the deployment, generate documents associated with any reported issues, etc.

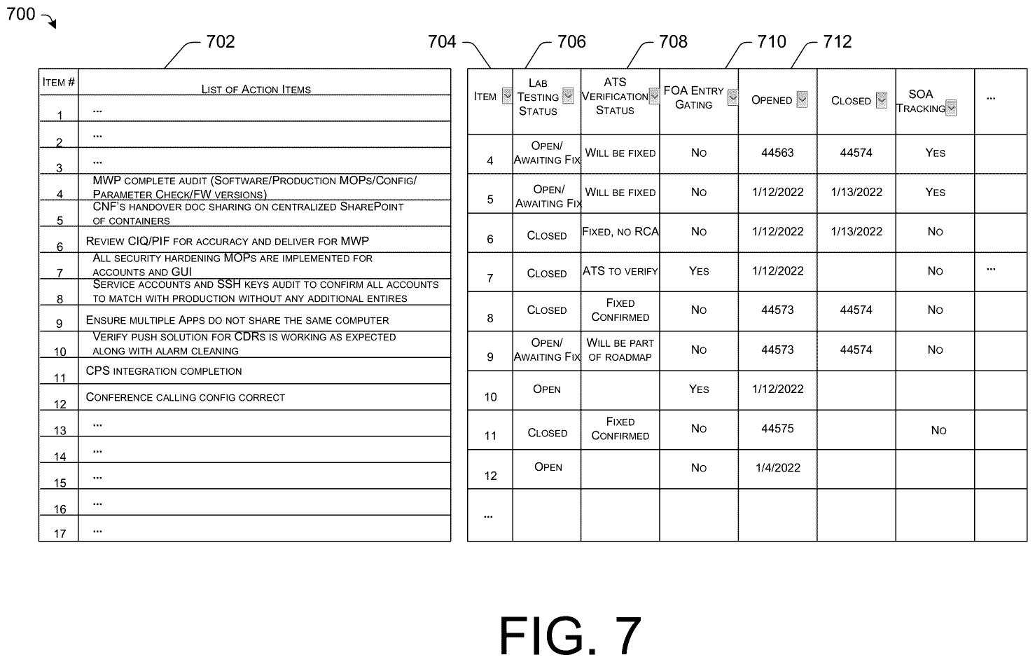

FIG. 7 illustrates an example view of a graphical user interface generated to guide the infrastructure project management and deployment tracking for deploying a new hardware, according to another example of the present disclosure.

The example view 700 of a graphical user interface may correspond to the example workflow 600 shown in FIG. 6, in which methods for infrastructure project management and deployment tracking for deploying a new hardware are implemented.

As shown in FIG. 7, the example view 700 of the graphical user interface may include one or more view windows to present different items associated with deploying the new hardware. A view window 702 may display a list of action items associated with the deployment. In examples, the list of action items may be organized into groups corresponding to different phases of the deployment. The view window 702, thus, provides a guidance to the teams engaged in the deployment to review, check, or complete the necessary steps for deployment.

In some examples, a view window 704 may be presented concurrently on the graphical user interface. The view window 704 may display a plurality of status associated with the action items in the view window 702. For instance, the view window 704 may display, for multiple action items in the view window 702, a lab testing status 706, a lab verification status 708, FOA entry gating status 710, ticket status 712, SOA tracking status 714, etc. As the graphical user interface shows the status associated with the workflow of the deployment, all teams engaged with the project may have an up-to-date view of the progress of the entire project workflow.

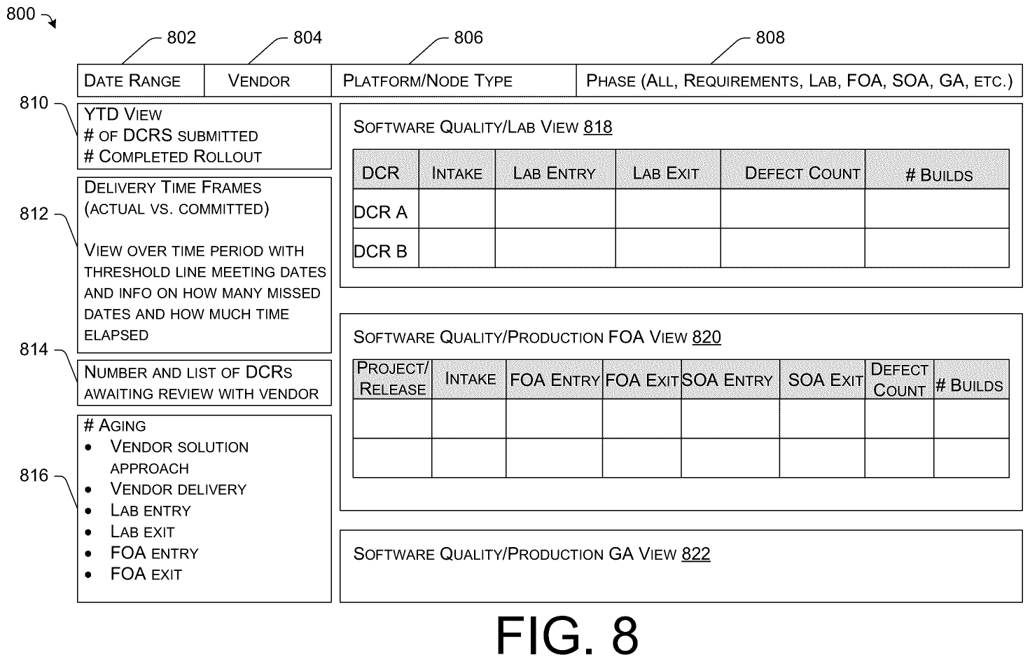

FIG. 8 illustrates another example view of a graphical user interface generated to guide the infrastructure project management and deployment tracking, according to yet another example of the present disclosure.

The example view 800 may demonstrate a reporting view of the deployed project. The example view 800 may include a date range 802 for generating the report, a vendor 804 related to vendor information, a platform/node type 806, a phase 808 to indicate the phases associated with the project. The example view 800 may further include a year-to-date (YTD) summary of the deployed project 810, a delivery time frames 812 to show the actual delivered project vs. the committed project, a number and list of DCRs waiting for review with the vendor 814, a number of aging 816, etc. In some examples, the example view 800 may further include a software quality/lab view 818, a software/production FOA view 820, and/or a software quality/production GA view 822 to compare the quality measurements of the software.

It should be understood that the example view 400, example view 500, example view 700, and example view 800, as illustrated in FIG. 4, FIG. 5, FIG. 7, and FIG. 8, respectively, are merely for the illustrative purposes. The computing device/server 206 of FIG. 2 may render different views of the graphical user interface to present the deployment progress at various phases of the workflow.

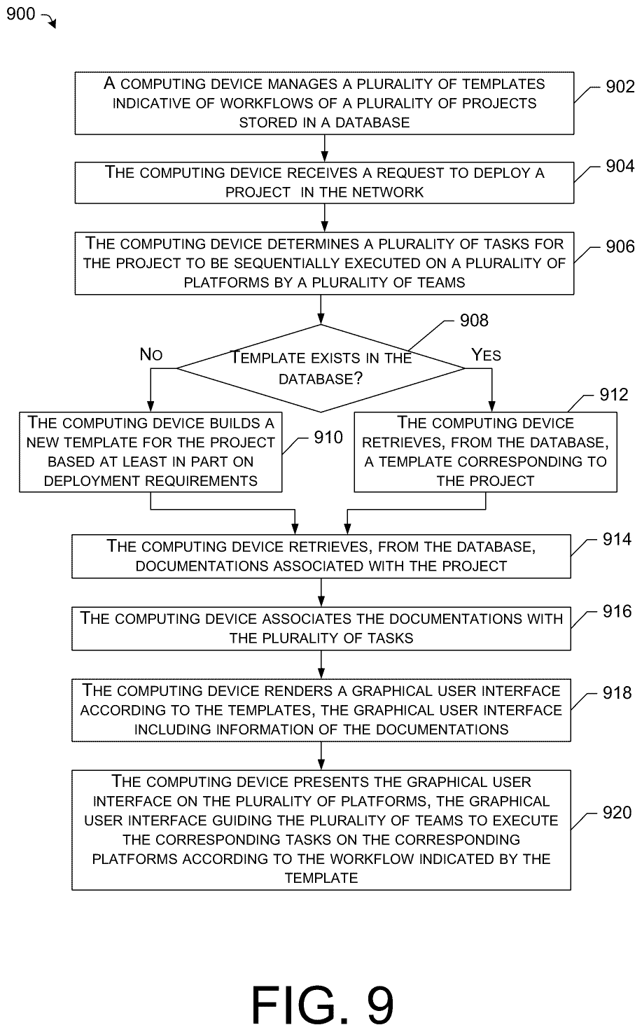

FIG. 9 illustrates an example process for infrastructure project management and deployment tracking, according to an example of the present disclosure. The example process 900 may be performed by the computing device/server 206 as shown in FIG. 2.

At operation 902, a computing device may manage a plurality of templates indicative of workflows of a plurality of projects stored in a database. As discussed herein, the plurality of templates may be standardized templates created to indicate standardized workflows of the projects in the past. In some examples, a template may indicate one or more teams (e.g., business units and/or technical teams) that are required to engage the project. The template may further indicate the types of data to be shared with the one or more teams during the deployment.

At operation 904, the computing device may receive a request to deploy a project in the network. A new project may be proposed by one or more vendors of the company or organization. The new project may be a new hardware such as a new node or a new server to be added to the network infrastructure. Alternatively or additionally, the new project may be a new software or a new version of a released software.

At operation 906, the computing device may determine a plurality of tasks for the project to be sequentially executed on a plurality of platforms by a plurality of teams. As discussed herein, to successfully deploy a new project in the network infrastructure, multiple teams may need to collaborate to complete all the tasks associated with the project. For example, adding a new node or a new server to the network may require a test to be done in a lab environment before the new node or the new server actually onboards. In another example, releasing a new software or a new version of a software may require the performance and/or functional testing to be done in the lab before the new software or the new version of the software goes to production.

At operation 908, the computing device may determine whether a template exists in the database. When a template does not exist in the database, at operation 910, the computing device may build a new template for the project based at least in part on deployment requirements, for example, timelines and milestones of the project, technical details and solutions to deploy the project, etc. The new template may be saved in a database coupled to the computing device, e.g., the database 204 of FIG. 2.

When a template exists in the database, at operation 912, the computing device may retrieve, from the database, a template corresponding to the project. As discussed herein, all existing templates may be stored in a centralized database. Based on the deployment requirement, the computing device may select a standardized template that is made suitable for the project.

At operation 914, the computing device may retrieve, from the database, documentations associated with the project. As discussed herein, at various phases of deploying the project, various teams may need to check, review, or complete one or more documentations related to the tasks performed at the various phases. The one or more documentations may be also saved in the centralized database. The computing device may identify the documentations required for each phase of the project and retrieve them from the centralized database.

At operation 916, the computing device may associate the documentations with the plurality of tasks. In some examples, the computing device may organize the documentations into multiple groups, each corresponding to a task to be performed during the deployment.

At operation 918, the computing device may render a graphical user interface according to the templates, the graphical user interface including information of the documentations. In examples, the graphical user interface may include an illustration of one or more phases along the project workflow. In some examples, the graphical user interface may further include a list of documentations required to check at each of the one or more phases. In yet other examples, the graphical user interface may further include a plurality of status indicators that indicate the status associated with the one or more phases such as the lab testing status indicator, the lab verification status, the FOA production status, the ticket status, etc.

At operation 920, the computing device may present the graphical user interface on the plurality of platforms, the graphical user interface guiding the plurality of teams to execute the corresponding tasks on the corresponding platforms according to the workflow indicated by the template. As discussed herein, data associated with the graphical user interface may be transmitted through a network to the plurality of teams operating on the plurality of platforms, causing the graphical user interface to be simultaneously displayed to the plurality of teams engaged with the project. By presenting the required documentations and the action status at each phase to all teams engaged in the project, the graphical user interface may guide these teams to complete their tasks efficiently.

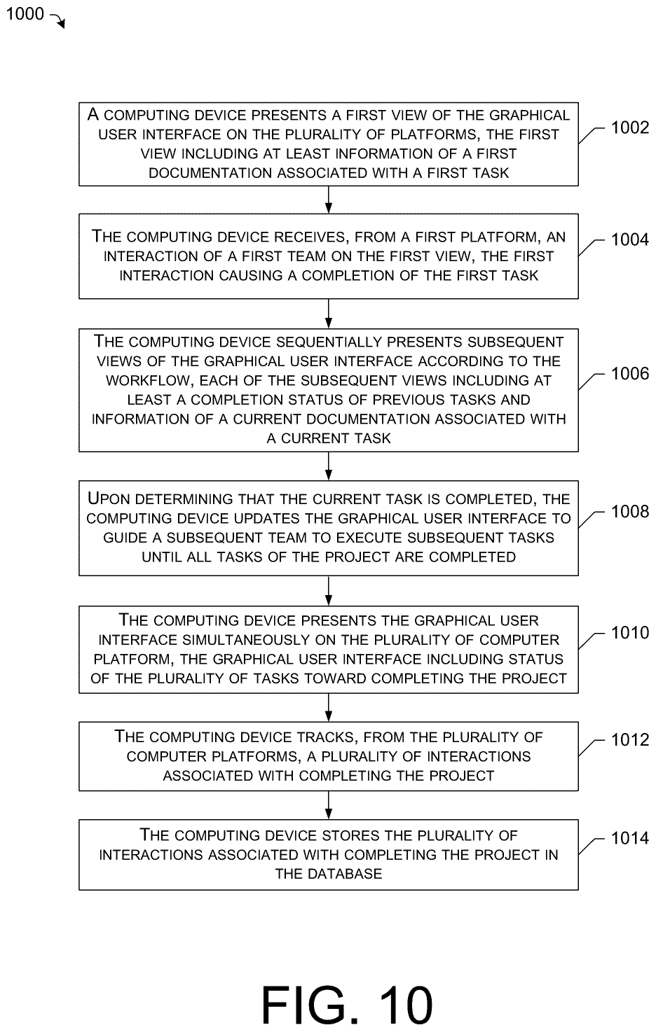

FIG. 10 illustrates an example process for infrastructure project management and deployment tracking, according to yet another example of the present disclosure. The example process 1000 may be performed by the computing device/server 206 as shown in FIG. 2.

At operation 1002, a computing device may present a first view of the graphical user interface on the plurality of platforms, the first view including at least information of a first documentation associated with a first task. In examples, the first view of the graphical user interface may show that the project is initiated and is with the first business unit/technical team for execution. An example of the first view of the graphical user interface may be referred to FIG. 4.

At operation 1004, the computing device may receive, from the first platform, an interaction of a team on the first view, the first interaction causing a completion of the first task. In some examples, the first view of the graphical user interface may include one or more user interaction fields that allow the user to perform actions related to the first task. Referring back to FIG. 4, when all the user interaction fields 410-422 are filled out, the user of the current team may click the “save” button, triggering a completion of the first task.

At operation 1006, the computing device may sequentially present subsequent views of the graphical user interface according to the workflow, each of the subsequent views including at least a completion status of previous tasks and information of a current documentation associated with a current task. As the computing device monitors the progress of the project deployment, the completion status of each phase along the workflow may be updated to the graphical user interface. For example, when a design phase is completed, the computing device may update the graphical user interface to present a subsequent view that shows the design phase being completed and the workflow being moved to the lab. An example of the subsequent view of the graphical user interface may be referred to FIG. 5.

At operation 1008, upon determining that the current task is completed, the computing device may update the graphical user interface to guide subsequent teams to execute the subsequent tasks until all tasks of the project are completed. Referring back to FIG. 5, the computing device may refresh the information displayed on the graphical user interface based on the up-to-date status of the project to guide the lab, FOA/SOA, and GA to complete the tasks of the project step-by-step.

At operation 1010, the computing device may present the graphical user interface simultaneously on the plurality of platform, the graphical user interface including status of the plurality of tasks associated with completing the project. In some examples, the computing device may transmit data related to the graphical user interface to the plurality of platforms through the network, causing the graphical user interface automatically displayed on the computing devices/servers on the plurality of platforms.

At operation 1012, the computing device may track, from the plurality of platforms, a plurality of interactions associated with completing the project. As discussed herein, while building the graphical user interface, the computing device may be configured to pull the data related to user interactions on the graphical user interface from the plurality of platforms periodically. Alternatively and/or additionally, the computing device may also receive the data related to user interactions on the graphical user interface from the plurality of platforms. In some examples, the user interactions on the graphical user interface may trigger a transmission of the data from the platform to the computing device through the network.

At operation 1014, the computing device may store the plurality of interactions associated with completing the project in the database. In some examples, the computing device may associate the plurality of interactions with the project and save the information for future analysis and/or regression test.

Although the example process 900 and the example process 1000 are depicted as including a number of operations and/or an apparent flow of operations, the example process 900 and the example process 1000 may each include more or less operations, repeat operations, and/or one or more of the operations may be conducted serially, in parallel, and/or in a different order than that shown in the figures.

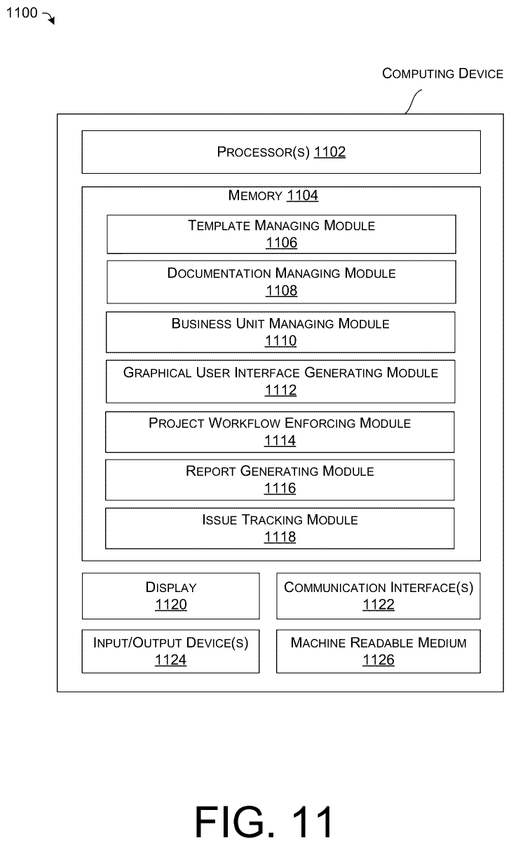

FIG. 11 illustrates an example computing device, in which methods for infrastructure project management and deployment tracking are implemented, according to an example of the present disclosure. The example computing device 1100 may correspond to the computing device/server 206 of FIG. 2.

As illustrated in FIG. 11, a computing device 1100 may comprise processor(s) 1102, a memory 1104 storing a template managing module 1106, a documentation managing module 1108, a business unit managing module 1110, a graphical user interface generating module 1112, a project workflow enforcing module 1114, a report generating module 1116, and an issue tracking module 1118, a display 1120, communication interface(s) 1122, input/output device(s) 1124, and/or a machine readable medium 1126.

In various examples, the processor(s) 1102 can be a central processing unit (CPU), a graphics processing unit (GPU), or both CPU and GPU, or any other type of processing unit. Each of the one or more processor(s) 1102 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 1102 may also be responsible for executing all computer applications stored in memory 1104, which can be associated with common types of volatile (RAM) and/or nonvolatile (ROM) memory.

In various examples, the memory 1104 can include system memory, which may be volatile (such as RAM), non-volatile (such as ROM, flash memory, etc.) or some combination of the two. The memory 1104 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 1100. Any such non-transitory computer-readable media may be part of the computing device 1100.

The template managing module 1106 may be configured to manage a plurality of standardized templates in a database. In some examples, the template managing module 1106 may build a new template for a new project based on the deployment requirements when no template is suitable for the new project.

The documentation managing module 1108 may be configured to manage the documentations required to deploy the project. By way of example and without limitation, the documentations may include project documentation such as project scope statement, project schedule, marketing plans, training plans, deployment plans, etc., technical documentation such as high level design and architecture, design documentation such as approved detailed technical and business requirements, config files, test plan, etc.

The business unit managing module 1110 may be configured to determine one or more business units or technical teams required to collaborate and complete the project. The business unit managing module 1110 may ensure that the one or more business units or technical teams are aligned on vision and scope, tools, and methodology, roles and responsibilities, dependencies and constraints, communication plans, high level deployment plans, timeline and key milestones, etc.

The graphical user interface generating module 1112 may be configured to generate the graphical user interface based at least in part on the deployment requirement of the project, the templates, the associated documentations, etc. In some examples, data with respect to a new project from the template managing module 1106, the documentation managing module 1108, and the business unit managing module 1110 may be sent to the graphical user interface generating module 1112. The computing device 1100 may transmit data associated with the graphical user interface through the network to the teams engaged with the project, causing the graphical user interface to be displayed on the computing devices of different teams. As discussed herein, the graphical user interface generating module 1112 may dynamically update the views of the graphical user interface to reflect the up-to-date status of the project.

The project workflow enforcing module 1114 may be configured to monitor the status of the workflow of the deployment. In some examples, the project workflow enforcing module 1114 may generate a notification to the business units/technical teams to engage the deployment process, particularly, in circumstances when some issues need the collaboration of all the business units/technical teams.

The report generating module 1116 may be configured to generate a report summarizing the deployment workflow. By way of example and without limitation, the report may include performance metrics such as FOA metrics in production, software quality comparison in views of the lab, the production team, the GA, etc., the issues reported during the deployment, delivery speed, etc.

The issue tracking module 1118 may be configured to track the issues occurred during the deployment and the tickets opened during the deployment. The issue tracking module 1118 may also record the actions taken to solve these issues by the one or more teams during the deployment. Data related to these issues and actions may be sent to the graphical user interface generating module 1112.

The communication interface(s) 1122 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 1122 can be compatible with multiple radio access technologies, such as 5G radio access technologies and 4G/LTE radio access technologies. Accordingly, the communication interfaces 1122 can allow the computing device 1100 to connect to the 5G system described herein.

Display 1120 can be a liquid crystal display or any other type of display commonly used in the computing device 1100. For example, display 1120 may be a touch-sensitive display screen and can then also act as an input device or keypad, such as for providing a soft-key keyboard, navigation buttons, or any other type of input. Input/output device(s) 1124 can include any sort of output devices known in the art, such as display 1120, speakers, a vibrating mechanism, and/or a tactile feedback mechanism. Input/output device(s) 1124 can also include ports for one or more peripheral devices, such as headphones, peripheral speakers, and/or a peripheral display. Input/output device(s) 1124 can include any sort of input devices known in the art. For example, input/output device(s) 1124 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 1126 can store one or more sets of instructions, such as software or firmware, that embodies any one or more of the methodologies or functions described herein. The instructions can also reside, completely or at least partially, within the memory 1104, processor(s) 1102, and/or communication interface(s) 1122 during execution thereof by the computing device 1100. The memory 1104 and the processor(s) 1102 also can constitute machine readable media 1126.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
a processor,
a network interface, and
a memory storing instructions executed by the processor to perform actions including:
managing a plurality of templates indicative of workflows of a plurality of projects stored in a database;
receiving a request to deploy a project in a network, the project including a plurality of tasks that are sequentially executed by a plurality of teams operating on a plurality of platforms, respectively;
retrieving, from the database, a template corresponding to the project;
rendering a graphical user interface based at least in part on the template; and
transmitting, though the network, data associated with the graphical user interface to the plurality of teams, causing the graphical user interface to be displayed on the plurality of platforms, wherein the graphical user interface guides the plurality of teams to execute the corresponding tasks according to the workflow indicated by the template.

2. The system of claim 1, wherein the actions further comprise:
retrieving, from the database, documentations associated with the project;
associating the documentations with the plurality of tasks of the project;
presenting a first view of the graphical user interface on the plurality of platforms, the first view including at least information of a first documentation associated with a first task; and
receiving, from a first computer platform, an interaction of a first team on the first view, the interaction causing a completion of the first task.

3. The system of claim 2, wherein
the information of the first documentation includes one or more documents required to complete the first task, and
the interaction includes at least selecting the one or more documents.

4. The system of claim 2, wherein the actions further comprise:
sequentially presenting subsequent views of the graphical user interface according to the workflow, each of the subsequent views including at least a completion status of one or more previous tasks and information of a current documentation associated with a current task; and
upon determining that the current task is completed, updating the graphical user interface to guide a subsequent team to execute a subsequent task,
wherein the information of the current documentation includes one or more documents required to complete the current task.

5. The system of claim 4, wherein the actions further comprise:
tracking, from the plurality of platforms, a plurality of interactions associated with completing the project; and
updating the data associated with the graphical user interface based at least in part on the plurality of interactions, causing an update of the graphical user interface presented on the plurality of platforms.

6. The system of claim 1, wherein deploying the project includes deploying a new hardware in the network, and the template corresponding to the project indicates the workflow that sequentially executes the plurality of tasks including at least
a first task to determine documentations associated with deploying the new hardware according to a requirement of deployment,
a second task to validate the deployment in a lab environment,
a third task to test the new hardware in the network after onboarding the new hardware, and
a fourth task to close out the project after successfully onboarding the new hardware and generate performance metrics of the new hardware.

7. The system of claim 6, wherein the new hardware includes at least one of a switch, a computer server, a router, or a cloud data center equipment.

8. The system of claim 1, wherein deploying the project includes releasing a new version of a software in the network, and the template corresponding to the project indicates the workflow that sequentially executes the plurality of tasks including at least
a first task to determine the plurality of teams associated with releasing the new version of the software,
a second task to determine documentations associated with releasing the new version of the software according to a criteria of release,
a third task to validate the release in a lab environment,
a fourth task to test the new version of the software in the network after releasing the new version of the software,
a fifth task to generate a rollout schedule based on the criteria, and
a sixth task to generate performance metrics of the new version of the software.

9. The system of claim 8, wherein the first task further provides a list of released versions of the software, and the actions further comprise:
presenting the graphical user interface to include the list of released versions of the software, and
receiving a selection of one or more released versions, causing bundling the one or more released versions with the new version of the software.

10. A computer-implemented method comprising:
managing a plurality of templates indicative of workflows of a plurality of projects stored in a database;
receiving a request to deploy a project in a network, the project including a plurality of tasks that are sequentially executed by a plurality of teams operating on a plurality of platforms, respectively;
retrieving, from the database, a template corresponding to the project;
rendering a graphical user interface based at least in part on the template; and
transmitting, though the network, data associated with the graphical user interface to the plurality of teams, causing the graphical user interface to be displayed on the plurality of platforms, wherein the graphical user interface guides the plurality of teams to execute the corresponding tasks according to the workflow indicated by the template.

11. The computer-implemented method of claim 10, further comprising:
retrieving, from the database, documentations associated with the project;
associating the documentations with the plurality of tasks of the project;
presenting a first view of the graphical user interface on the plurality of platforms, the first view including at least information of a first documentation associated with a first task; and
receiving, from a first computer platform, an interaction of a first team on the first view, the interaction causing a completion of the first task.

12. The computer-implemented method of claim 11, wherein
the information of the first documentation includes one or more documents required to complete the first task, and
the interaction includes at least selecting the one or more documents.

13. The computer-implemented method of claim 11, further comprising:
sequentially presenting subsequent views of the graphical user interface according to the workflow, each of the subsequent views including at least a completion status of one or more previous tasks and information of a current documentation associated with a current task; and
upon determining that the current task is completed, updating the graphical user interface to guide a subsequent team to execute a subsequent task,
wherein the information of the current documentation includes one or more documents required to complete the current task.

14. The computer-implemented method of claim 13, further comprising:
tracking, from the plurality of platforms, a plurality of interactions associated with completing the project; and
updating the data associated with the graphical user interface based at least in part on the plurality of interactions, causing an update of the graphical user interface presented on the plurality of platforms.

15. The computer-implemented method of claim 10, wherein deploying the project includes deploying a new hardware in the network, and the template corresponding to the project indicates the workflow that sequentially executes the plurality of tasks including at least
a first task to determine documentations associated with deploying the new hardware according to a requirement of deployment,
a second task to validate the deployment in a lab environment,
a third task to test the new hardware in the network after onboarding the new hardware, and
a fourth task to close out the project after successfully onboarding the new hardware and generate performance metrics of the new hardware.

16. The computer-implemented method of claim 15, wherein the new hardware includes at least one of a switch, a computer server, a router, or a cloud data center.

17. The computer-implemented method of claim 10, wherein deploying the project includes releasing a new version of a software in the network, and the template corresponding to the project indicates the workflow that sequentially executes the plurality of tasks including at least
a first task to determine the plurality of teams associated with releasing the new version of the software,
a second task to determine documentations associated with releasing the new version of the software according to a criteria of release,
a third task to validate the release in a lab environment,
a fourth task to test the new version of the software in the network after releasing the new version of the software,
a fifth task to generate a rollout schedule based on the criteria, and
a sixth task to generate performance metrics of the new version of the software.

18. The computer-implemented method of claim 17, wherein the first task further provides a list of released versions of the software, and the computer implemented-method further comprises:
presenting the graphical user interface to include the list of released versions of the software, and
receiving a selection of one or more released versions, causing bundling the one or more released versions with the new version of the software.

19. A non-transitory computer-readable storage medium storing computer-readable instructions, that when executed by a processor, cause the processor to perform actions comprising:
managing a plurality of templates indicative of workflows of a plurality of projects stored in a database;
receiving a request to deploy a project in a network, the project including a plurality of tasks that are sequentially executed by a plurality of teams operating on a plurality of platforms, respectively;
retrieving, from the database, a template corresponding to the project;
rendering a graphical user interface based at least in part on the template; and
transmitting, though a network, data associated with the graphical user interface to the plurality of teams, causing the graphical user interface to be displayed on the plurality of platforms, wherein the graphical user interface guides the plurality of teams to execute the corresponding tasks according to the workflow indicated by the template.

20. The non-transitory computer-readable storage medium of claim 19, wherein the actions further include:
retrieving, from the database, documentations associated with the project;
associating the documentations with the plurality of tasks of the project;
presenting a first view of the graphical user interface on the plurality of platforms, the first view including at least information of a first documentation associated with a first task;
receiving, from a first computer platform, an interaction of a first team on the first view, the interaction causing a completion of the first task;
sequentially presenting subsequent views of the graphical user interface according to the workflow, each of the subsequent views including at least a completion status of one or more previous tasks and information of a current documentation associated with a current task, and
upon determining that the current task is completed, updating the graphical user interface to guide a subsequent team to execute a subsequent task,
wherein the information of the current documentation includes one or more documents required to complete the current task.
